(19) United States
(12) Patent Application Publication
(10) Pub. No.: US 2013/0264151 A1
(43) Pub. Date: Oct. 10, 2013

(54) EQUIPMENT FOR JOINING ELEVATOR GUIDE RAILS, JOINT ARRANGEMENT FOR ELEVATOR GUIDE RAILS, AND ELEVATOR

(71) Applicant: KONE CORPORATION, Helsinki (FI)

(72) Inventors: Johannes KOIVUKANGAS, Vantaa (FI); Antti PLATHIN, Vantaa (FI); Petter MARTONEN, Kauniainen (FI)

(73) Assignee: KONE Corporation, Helsinki (FI)

(21) Appl. No.: 13/859,102

(22) Filed: Apr. 9, 2013

(30) Foreign Application Priority Data
Apr. 10, 2012 (FI) 20125392

(51) Int. Cl. B66B 7/02

(52) U.S. Cl. CPC B66B 7/026
USPC 187/406; 403/306

(57) ABSTRACT

Equipment is provided for joining elevator guide rails, for connecting consecutive guide rails of an elevator to each other, which equipment includes a fish plate, which fish plate is an elongated angle plate profile piece including a plurality of plate sections that are beside each other and in the length direction of the fish plate, and longitudinal bends between the plate sections that are beside each other, and which plate section plurality including a planar support plate section, against which support plate section the rear sides of the ends of consecutive guide rails can be supported to lean, and which plate section plurality also includes stiffening plate sections bent away from the plane of the support plate section. A joint arrangement is provided for the guide rails of an elevator and an elevator, in which arrangement and elevator the joining equipment is used.

### FIELD OF THE INVENTION

The invention relates to joining together the guide rails of an elevator. The object of the invention is equipment for joining elevator guide rails, a joint arrangement for elevator guide rails, and an elevator, in which case the elevator in question is preferably an elevator applicable to passenger transport and/or to freight transport.

### BACKGROUND OF THE INVENTION

The movement of moving elevator units in elevators, such as the elevator car and a possible counterweight, is guided by one or more guide rail lines in the direction of the movement of the elevator units. A moving elevator unit often also comprises a brake, which is arranged to grip a guide rail of the guide rail line in an emergency situation for braking the movement of the moving elevator unit. Each guide rail line comprises a plurality of guide rails placed consecutively, which guide rails thus form a section of the aforementioned guide rail line. According to prior art, the consecutive guide rails are connected to each other with a joint plate, for which the designation “fish plate” is used. The fish plate is fixed to the ends of consecutive guide rails, to the rear side of the guide rail, on which side the guide rails do not comprise a guide surface for a moving elevator unit of the elevator. The fish plate in this way rigidly fixes the ends of the guide rails to each other. Conventionally, a fish plate has been a flat plate of uniform thickness, which is fixed with a bolt fastening to both consecutively placed ends of a guide rail. The aim of the joint is to be able to prevent the guide rails moving away from each other in the longitudinal direction or in the lateral direction, or from bending in relation to each other. Displacement of the guide rail ends in relation to each other is disadvantageous, because displacement will cause a step or a gap between them, which forms a point of discontinuity. The discontinuity points or changes of gradient between guide rails are detrimental from the viewpoint of ride comfort and safety for the guide shoe guided by the guide rail or for the brake of the moving elevator unit being able to grip the guide rail. Thus the goal is for the guide rail line to be unbroken and straight. A moving elevator unit takes lateral guiding force from the guide rails during its guidance and/or longitudinal support force of the guide rail when it brakes by gripping to the guide rail. In these types of situations longitudinal force, lateral force and bending act on the joint between consecutive guide rails. Strong torsion forms between the guide rail ends during operation of the elevator, from inter alia the effect of the torque arm produced by the length of the guide rails, and when the joining equipment is generally the only element resisting torsion. That being the case, from the viewpoint of the joint, its ability to resist bending is highly critical. The ability of a joint to resist bending or other displacements between guide rails is important when an elevator unit is at the point of the joint, but also when the elevator unit is at a distance from the joint in question, namely the guide rail line is an entity in which a number of guide rails support each other. For example, the bottommost guide rails can support the higher guide rails on top of them. The bending rigidity of a joint is conventionally increased by forming the fish plate of the joining equipment from thick plate. This is an effective method, but one problem is that the number of fish plates per elevator is high, in which case the material consumption of individual fish plates is high when aggregated. The space usage of joining equipment/a joint arrangement is one important factor that must be taken into account. The joining equipment is generally very close to the path of movement of the parts of an elevator unit moving along the guide rail line in question. The joining equipment must be away from the aforementioned path of movement to avoid collisions. On the other hand, they form a protrusion from the guide rail line, said protrusion being in connection with the guide rail, and thus they limit the possibility of disposing a guide rail very close to the wall of the elevator hoistway or to other components. For this reason, the aim must be to form compact joining equipment.

Taking the preceding into account, a need has arisen for joining equipment with which a joint that is economic, space-efficient and rigid can be achieved better than before between consecutive guide rails.

### BRIEF DESCRIPTION OF THE INVENTION

The aim of the present invention is to solve the aforementioned problems of prior-art solutions as well as the problems disclosed in the description of the invention below. One aim is, inter alia, to produce a rigid joint between the consecutive guide rails of an elevator, said joint having lower material consumption than before. Embodiments, inter alia, are disclosed in which the joining equipment produces a rigid joint and the space taken in the elevator hoistway by the joining equipment is little.

The joining equipment, according to the invention for elevator guide rails, for joining consecutive elevator guide rails to each other, comprises a fish plate, which fish plate is an elongated angle plate profile piece comprising a plurality of plate sections that are beside each other and in the length direction of the fish plate, and longitudinal bends between the plate sections that are beside each other, and the aforementioned plurality of plate sections comprises a planar support plate section or a plurality of coplanar planar support plate sections, against which support plate section/which support plate sections the rear sides of the ends of consecutive guide rails can be supported to lean, and which plate section plurality also comprises stiffening plate sections bent away from the plane of the support plate section/support plate sections. One advantage is that the fish plate is cheap to fabricate, because an angle plate structure is fast and simple. The shaping of the fish plate increases its rigidity, in which case the material thickness can be kept thin.

Preferably the aforementioned stiffening sections of the fish plate of the joining equipment comprise stiffening plate sections bent away from the plane of the support plate section, which stiffening plate sections are at an angle with respect to the aforementioned support plate section and/or stiffening plate sections, which are not at an angle with respect to the aforementioned support plate section, and the guide rail placed to lean against the aforementioned support plate section does not lean against the stiffening plate section.

In one embodiment the aforementioned fish plate of the joining equipment comprises on opposite sides of the support plate section a first stiffening plate section diverging to the front side of the support plate section, and a second stiffening plate section diverging to the rear side of the support plate section. In this way the dimension of the fish plate in the depth direction (z-direction) is large and achieves a large second moment of area with low material consumption, at the same time however enabling a compact guide rail configuration. Preferably the first stiffening plate section is on the first longitudinal edge of the fish plate, and diverges from the support plate section towards the front side of the support plate section (and also of the fish plate), i.e. towards the guide rail side, and the second stiffening plate section is on the second longitudinal edge of the fish plate, and diverges from the support plate section towards the rear side of the support plate section. Preferably, but not necessarily the first stiffening plate section and the second stiffening plate section are bent to be parallel and at a right angle with respect to the support plate section, in which case the stiffening effect is at its greatest with respect to space consumption. Preferably the fish plate comprises only 2 longitudinal bends, two stiffening plate sections and one support plate section.

In one embodiment the aforementioned fish plate of the joining equipment comprises two parallel coplanar support plate sections at a transverse distance (in the x-direction) from each other, against which support plate sections the rear sides of the ends of consecutive guide rails can be supported to lean, and stiffening plate sections that are bent away from the plane of the support plate sections and that connecting the aforementioned two parallel coplanar support plate sections. In this way the dimension of the fish plate in the depth direction (z-direction) is large and achieves a large second moment of area with low material consumption, at the same time however enabling a compact guide rail configuration, because the lateral (x-direction) size of the fish plate can be formed to be small. Preferably the aforementioned stiffening plate sections are disposed between the aforementioned two parallel coplanar support plate sections. In this way the fish plate can be arranged to form in the area of the edges of the fish plate only a slight protrusion from the projection of the guide rail. Another advantage is also that the stiffening plate sections between the aforementioned coplanar support plate sections can be beside the fixing means, e.g. bolts, as viewed from the z-direction. Another advantage is that the fish plate can be varied for different needs, more particularly for guide rails of different sizes or having a different transverse distance of the holes, with small modifications using essentially the same cross-sectional profile. Namely the aforementioned coplanar support plate sections can be configured to be at a suitable distance from each other by configuring the angle of the bend between them and the stiffening plate sections to be such that the support plate sections are at a suitable distance from each other. This can be necessary e.g. so that the holes of the support plate sections can be fitted face-to-face with the holes of a guide rail. Preferably in this embodiment the stiffening plate sections form a depression disposed between the aforementioned support plate sections that is pressed down towards the rear side of the fish plate. Preferably the aforementioned stiffening plate sections comprise a first stiffening plate section that is at an angle with respect to the aforementioned support plate sections and bent from one support plate section towards the rear side, and a second stiffening plate section that is at an angle with respect to the aforementioned support plate sections and bent from the second support plate section towards the rear side. Between the first stiffening plate section and the second stiffening plate section can be a stiffening plate section parallel in relation to the support plate sections but on a different plane in relation to the support plate sections. Alternatively, the first stiffening plate section and the second stiffening plate section are plate sections that are side-by-side. In this case there is preferably a bend between them. The angle of the bend is preferably at most 120 degrees, preferably at most 100 degrees.

Preferably the joining equipment comprises fixing means for fixing the guide rails to the support plate, more particularly for fixing the guide rails to lean against the support plate section of the fish plate. Preferably the fixing means comprise through-holes in the fish plate, which holes preferably travel through the support plate section. Preferably the fixing means also comprise joint means, such as bolts, that can be tightened for achieving bolt tightening.

The fish plate is preferably of metal, e.g. steel, in its material. The material thickness of it is preferably constant. The fish plate is preferably an angle plate profile piece of uniform metal material, which is bent from plate, in which case the aforementioned shapes are achieved in it by bending. The material thickness of the fish plate is preferably between 3 mm-2 cm, more preferably 5 mm-1.5 cm.

In the joint arrangement according to the invention for the guide rails of an elevator the guide rail line, which comprises consecutive guide rails that are in line and similar in cross-sectional shape, the consecutive guide rails are connected to each other with joining equipment according to any of those described in the preceding, in such a way that the rear sides of the ends of consecutive guide rails are fixed to a fish plate to lean against the same support plate section/support plate sections of the fish plate. Preferably the rear sides of the ends of the guide rails are fixed to a fish plate to lean against the (same) support plate section/support plate sections (as each other) of the fish plate with tightenable joint means, preferably with a bolt fastening.

In one preferred embodiment of the joint arrangement the fish plate comprises on opposite sides of the support plate section a first stiffening plate section diverging to the front side of the support plate section, and a second stiffening plate section diverging to the rear side of the support plate section, and the rear sides of the ends of the guide rails are fixed to a fish plate to lean against the support plate section/support plate sections of the fish plate with tightenable joint means, which form a bolt fastening, in which the head of the bolt and the guide rail are at least partly beside the first stiffening plate section when viewed in the depth direction (z) of the guide rail, and the nut of the bolt is at least partly beside the second stiffening plate section when viewed in the depth direction (z) of the guide rail. In this way a rigid joint is achieved, the material consumption of which fish plate is small while at the same time the overall structure of the joint is very compact.

The elevator according to the invention comprises one or more elevator units to be moved, including at least an elevator car, and possibly a counterweight, and a guide rail line of an elevator unit, which guide rail line comprises consecutive guide rails that are in line and similar in cross-sectional shape, and the consecutive guide rails are connected to each other with a joint arrangement according to any of those described in the preceding.

The elevator is most preferably an elevator applicable to the transporting of people and/or of freight, which elevator is installed in a building, to travel in a vertical direction, or at least in an essentially vertical direction, preferably on the basis of landing calls and/or car calls. The elevator car preferably has an interior space, which is most preferably suited to receive a passenger or a number of passengers. The elevator preferably comprises at least two, preferably more, floor landings to be served. Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the framework of the basic inventive concept in conjunction with other embodiments.

### BRIEF DESCRIPTION OF THE FIGURES

The invention will now be described in more detail in connection with its preferred embodiments, with reference to the attached drawings, wherein:

FIGS. 1a-1c present a cross-section of a fish plate of equipment for joining the guide rails of an elevator, a three-dimensional view of a fish plate and a joint arrangement with joint means that are according to a first embodiment of the invention.

FIGS. 2a-2c present a cross-section of a fish plate of equipment for joining the guide rails of an elevator, a three-dimensional view of a fish plate and a joint arrangement with joint means that are according to a second embodiment of the invention.

FIGS. 3a-3c present a cross-section of a fish plate of equipment for joining the guide rails of an elevator, a three-dimensional view of a fish plate and a joint arrangement with joint means that are according to a third embodiment of the invention.

FIG. 4 presents a side view of an elevator according to one embodiment.

### DETAILED DESCRIPTION OF THE INVENTION

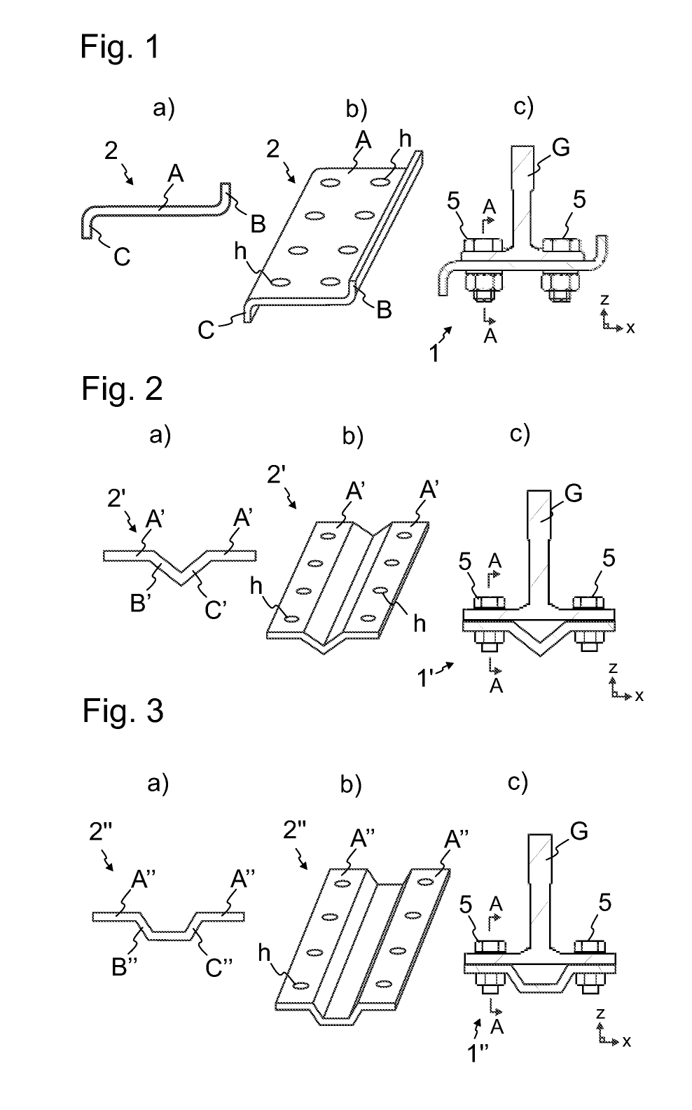

Each of FIGS. 1-3 present equipment 1, 1′, 1″ for joining the guide rails of an elevator, for joining the consecutive guide rails G of the elevator to each other, which equipment comprises a fish plate 2, 2′, 2″, which fish plate 2, 2′, 2″ is an elongated angle plate profile piece comprising a plurality of plate sections A, B, C; A′, B′, C′; A″, B″, C″ that are beside each other and in the length direction of the fish plate, and longitudinal bends between the plate sections that are beside each other, in which case as a consequence of the bend the plate sections that are beside each other are at an angle in relation to each other.

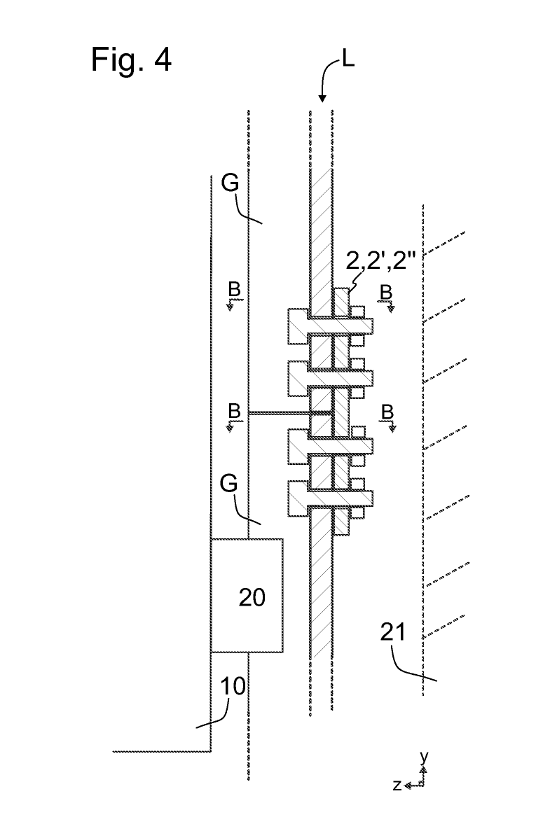

The plate section plurality in the embodiment of FIG. 1 comprises a planar support plate section A and in the embodiments of FIGS. 2-3 a plurality of coplanar planar support plate sections A′, A″, against which support plate section/which support plate sections A, A′, A″ the rear sides of the ends of consecutive guide rails G can be supported to lean. In the embodiments presented the plate section plurality of a fish plate 2, 2′, 2″ also comprises stiffening plate sections B, C; B′, C′; B″, C″ bent away from the plane of a support plate section A, A′, A″, e.g. stiffening plate sections B, C; B′, C′; B″, C″ bent away from the plane of the support plate section A, A′, A″, which stiffening plate sections are at an angle with respect to the aforementioned support plate section. The guide rail G placed/to be placed to lean against the aforementioned support plate section A, A′, A″ does not lean against the stiffening plate sections B, C; B′, C′; B″, C″, but instead the plate sections in question are primarily intended to stiffen the fish plate. FIGS. 1a, 2a, 3a each present a cross-section of a fish plate of the embodiment in question, FIGS. 1b, 2b, 3b a three-dimensional view of the fish plate, and FIGS. 1c, 2c, 3c a cross-section of the joint arrangement of a guide rail of an elevator, wherein a guide rail G is fixed against the fish plate of the embodiment of the figure in question. Each of the joint arrangements of a guide rail of FIGS. 1-3 is preferably according to FIG. 4, in which case FIGS. 1c, 2c and 3c present a cross-section at the point B-B of FIG. 4. FIG. 4 also presents the elevator car 10 of the elevator and the guide shoe 20 connected to the elevator car 10, and illustrates the possible location of the wall 21 of the elevator hoistway.

In the embodiment presented in FIG. 1, the fish plate 2 of the joining equipment comprises on opposite sides of the support plate section A a first stiffening plate section B diverging to the front side of the support plate section A, and a second stiffening plate section C diverging to the rear side of the support plate section. The first stiffening plate section B is on the first longitudinal edge of the fish plate 2, and diverges from the support plate section A towards the front side of the support plate section A, and thus also to the front side of the fish plate, which is the side on which the guide rail G is when the guide rail G is supported against the fish plate. The second stiffening plate section C is on the second longitudinal edge of the fish plate 2, and diverges from the support plate section A towards the rear side of the support plate section A, and thus also to the rear side of the fish plate, which is the opposite side than the side on which the guide rail G is when the guide rail G is supported against the fish plate. With the shape presented good rigidity is achieved in the z-direction with, however, the fish plate taking only a little space. In this way the dimension of the z-direction of the fish plate piece can be doubled compared e.g. to if both the stiffening plate sections C were to diverge to the front side or to the rear side. Good rigidity is achieved because the second moment of area resisting bending around the x-axis of the piece is large. The solution is, however, compact because both the stiffening plate sections B and C can to a large extent be placed side-by-side with the fixing means 5 belonging to the joining equipment and with the guide rail itself. Thus the joint arrangement to be achieved is rigid while, however, taking up little space. The rigidity achieved, on the other hand, enables a thinner fish plate than before to be used for achieving the required rigidity. That being the case, the solution enables savings in material. When using tightenable fixing means 5, such as a bolt fastening, as the fixing means of the joint, the largest distance in the z-direction of the fixing means from the rear side of the guide rail is small, in which case the guide rail can be fixed closer than before to the elevator structures on the rear side of the guide rail, such as e.g. closer to the wall of the elevator hoistway. The stiffening plate section diverging towards the front side and towards the rear side, and also the support plate section, are preferably implemented as presented in the figures, in which case there are only two longitudinal bends in the fish plate. Preferably in this case there are only three longitudinal plate sections one beside another (in the figure plate sections B, A, C).

In the embodiment presented in FIGS. 2-3, the fish plate 2′, 2″ of the joining equipment comprises two parallel coplanar support plate sections (A′; A″), against which support plate sections A′; A″ the rear sides of the ends of consecutive guide rails G are supported/can be supported to lean, and the fish plate also comprises stiffening plate sections B′, C′; B″, C″, D″ that are bent away from the plane of the support plate sections A′; A″ and that connect the aforementioned two parallel coplanar support plate sections A′; A″. The aforementioned stiffening plate sections B′, C′; B″, C″ are between the aforementioned two parallel coplanar support plate sections A′; A″, forming a depression between the aforementioned support plate sections A′; A″ that is pressed down towards the rear side of the fish plate 2′; 2″. The aforementioned stiffening plate sections B′, C′; B″, C″, D″ comprise a first stiffening plate section B′; B″ that is at an angle with respect to the aforementioned support plate sections A′; A″ and bent from one support plate section A′; A″ towards the rear side, and a second stiffening plate section C′; C″ that is at an angle with respect to the aforementioned support plate sections (A′; A″) and bent from the second support plate section A′; A″ towards the rear side. In the embodiment of FIG. 2, the aforementioned first stiffening plate section B′; B″ and the second stiffening plate section C′; C′ are plate sections that are side-by-side. Between them is a bend that forms an angle; the angle is preferably at most 120 degrees, preferably at most 100 degrees. In this case the diverging of the depression can be formed to be narrow and deep, in which case the stiffening effect is large, however enabling the close placement of the support plate sections in relation to each other and consequently the fixing holes can be formed to be close to each other in the support plate sections. The aforementioned angle could also, however, be of another magnitude. The formation of a small rounding can be permitted at the point of the bend. In the embodiment presented the stiffening plate sections B′, C′ are planar, but they can alternatively be curved. For example, in the embodiment of FIG. 2 the stiffening plate sections B′ and C′ can be curved, in which case a visible sharp corner point does not necessarily form between them, e.g. if the bend between the stiffening plate sections B′ and C′ were almost the same, or even the same, in their bending radius as the own radius of curvature of the stiffening plate sections in question. The embodiment of FIG. 3 is otherwise similar to the embodiment of FIG. 2, but here between the first stiffening plate section B″ and the second stiffening plate section C″ is a stiffening plate section D″ parallel in relation to the support plate sections A″ but on a different plane. In this way a structure is achieved that has large cross-sectional areas (the cross-sectional areas of the sections D″ and A″) separate from each other in the z-direction. Owing to this, the second moment of area resisting bending around the axis of the x-direction of the piece is large in terms of the cross-section, and the piece can thus be formed, even with thin material thickness, to be rigid in the z-direction, i.e. to strongly resist bending around the x-axis of the width direction. Also the rigidity achieved with the embodiments of FIGS. 2-3 enables a thinner fish plate 2′, 2″ than before to be used for achieving the required rigidity. That being the case, the solutions enable savings in material. Another advantage is that when using tightenable fixing means 5, such as a bolt fastening, as the fixing means of the joint, the largest distance in the z-direction of the fixing means from the rear side of the guide rail is small, in which case the guide rail can be fixed closer than before to the elevator structures on the rear side of the guide rail, such as e.g. closer to the wall of the elevator hoistway. Yet another advantage of the solutions of FIGS. 2-3 is that the fish plate can be varied for different needs, more particularly for guide rails of different sizes or having a different transverse distance of the holes, with small modifications using essentially the same cross-sectional profile. Namely the support plate sections A′; A″ can be configured to be at a suitable distance from each other by configuring the angle of the bend between them and the stiffening plate sections B′, C′; B″, C″ to be such that the support plate sections are at a suitable distance from each other, so that the hole in them can be fitted face-to-face with a hole in the guide rail.

In the embodiments presented the joining equipment 1, 1′, 1″ further comprises fixing means 5 for fixing the ends of the guide rails G to the fish plate 2, 2′, 2″, more particularly for fixing the ends of the guide rails G to lean against the support plate section/support plate sections A, A′, A″ of the fish plate 2, 2′, 2″. The joining equipment 1, 1′, 1″ preferably comprises through-holes h in the fish plate. The through-holes h travel through the support plate section A, A′, A″ in its thickness direction z. There are a number of through-holes, distributed in the longitudinal direction (i.e. in the y-direction) of the fish plate 2, 2′, 2″ above and below the midpoint of the height of the fish plate 2, 2′, 2″, in which case two consecutive guide rails G can be fixed to the fish plate, and each has its own through-holes provided. There are preferably 4 units of through-holes for both guide rails G, as presented in the figures. The guide rails G comprise through-holes with a corresponding distribution for placing face-to-face with the holes of the fish plate. In this way a tightenable bolt can be placed through the guide rails and the fish plate 2, 2′, 2″. The bolt fastening is preferably of the type presented, i.e. a bolt placed through the fish plate 2, 2′, 2″ (the support plate section of it) and a guide rail G, which bolt tightens the fish plate 2, 2′, 2″ and guide rail G together, e.g. with a nut that can be screwed to tighten, which nut is on the opposite side of the tightening bundle than the head of the bolt.

FIG. 4 presents an elevator according to one embodiment, in which elevator is a joint arrangement, comprising a fish plate, according to any of FIG. 1c, 2c or 3c. Each joint arrangement according to FIG. 1c, 2c or 3c is preferably according to FIG. 4 at the point of its cross-section B-B. The joint arrangement of FIG. 4 can be according to FIG. 1c, 2c or 3c at the point of the cross-section A-A. In the joint arrangement the guide rail line L, which guide rail line L comprises consecutive guide rails G that are face-to-face in line and similar in cross-sectional shape, which consecutive guide rails G are connected to each other with joining equipment according to any of FIG. 1, 2 or 3 in such a way that the rear sides of the ends of consecutive guide rails G are fixed to a fish plate 2, 2′, 2″ to lean against the same support plate section/support plate sections A, A′, A″ of the fish plate. The rear sides of the ends of the guide rails G are fixed to a fish plate 2, 2′, 2″ to lean against the same support plate section/support plate sections A, A′, A″ of the fish plate with tightenable joint means 5, preferably with a bolt fastening as presented.

The fish plate 2, 2′, 2″ is preferably of metal, e.g. steel, in its material. The material thickness of it is preferably constant. The material thickness of it is preferably between 3 mm-2 cm, more preferably 5 mm-1.5 cm. The fish plate is preferably bent into its shape from a flat plate. The holes of the fish plate/guide rails could be disposed in an alternative manner to what is presented. The number of them can, alternatively, also be other than what is presented. The rear sides of the ends of consecutive guide rails G can be fixed to lean on a fish plate 2, 2′, 2″, against its support plate section/support plate sections A, A′, A″, with a direct contact, as is presented, but alternatively the rear sides of the ends of the guide rails G can be fixed to lean on a fish plate 2, 2′, 2″, against its support plate section/support plate sections A, A′, A″, via a thin spacing plate (not presented). Preferably the aforementioned joining equipment is for connecting guide rails having a planar rear side to each other.

The guide rail G can be T-shaped in its cross-section, as is presented in the figures, but the joint presented is also applicable in connection with other types of guide rails. FIG. 4 presents an elevator, wherein the guide rail line L is the guide rail line of the elevator car 10, but the guide rails of the guide rail line of a possible counterweight could also be formed in a corresponding manner. The term “angle plate profile piece” refers to a piece having a cross-section that is essentially the same in the longitudinal direction of the piece, and which is fabricated from plate and having a profile comprising angles. It is obvious to the person skilled in the art that in developing the technology the basic concept of the invention can be implemented in many different ways. The invention and the embodiments of it are not limited to the examples described above, but instead they may be varied within the scope of the claims.

1. Equipment for joining elevator guide rails, for connecting consecutive guide rails of an elevator to each other, which equipment comprises a fish plate, which fish plate is an elongated angle plate profile piece comprising a plurality of plate sections that are beside each other and in the length direction of the fish plate, and longitudinal bends between the plate sections that are beside each other, and which plate section plurality comprises a planar support plate section or a plurality of coplanar planar support plate sections, against which support plate section/which support plate sections the rear sides of the ends of consecutive guide rails can be supported to lean, and which plate section plurality also comprises stiffening plate sections bent away from the plane of the support plate section/support plate sections.

2. Joining equipment according to claim 1, in which equipment the aforementioned stiffening sections comprise on opposite sides of the support plate section a first stiffening plate section diverging to the front side of the support plate section, and a second stiffening plate section diverging to the rear side of the support plate section.

3. Joining equipment according to claim 1, in which equipment the first stiffening plate section and the second stiffening plate section are parallel with each other and at right angles with respect to the support plate section.

4. Joining equipment according to claim 1, in which equipment the fish plate comprises two parallel coplanar support plate sections, against which support plate sections the rear sides of the ends of consecutive guide rails can be supported to lean, and also stiffening plate sections that are bent away from the plane of the support plate sections and that connect the aforementioned two parallel coplanar support plate sections.

5. Joining equipment according to claim 4, in which equipment the aforementioned stiffening plate sections are disposed between the aforementioned two parallel coplanar support plate sections.

6. Joining equipment according to claim 4, in which equipment the aforementioned stiffening plate sections comprise a first stiffening plate section that is at an angle with respect to the aforementioned support plate sections and bent from one support plate section towards the rear side, and a second stiffening plate section that is at an angle with respect to the aforementioned support plate sections and bent from the second support plate section towards the rear side.

7. Joining equipment according to claim 1, in which the joining equipment comprises fixing means for fixing the guide rails to the fish plate, more particularly for fixing the guide rails to lean against the support plate section of the fish plate.

8. Joint arrangement for the guide rails of an elevator, said arrangement comprising a guide rail line, which comprises consecutive guide rails that are in line and similar in cross-sectional shape, wherein the consecutive guide rails are connected to each other with a joint arrangement according to claim 1 in such a way that the rear sides of the ends of consecutive guide rails are fixed to a fish plate to lean against the support plate section/support plate sections of the fish plate.

9. Joint arrangement according to claim 8, in which arrangement the rear sides of the ends of guide rails are fixed to a fish plate to lean against the support plate section/support plate sections of the fish plate with tightenable joint means, preferably with a bolt fastening.

10. Joint arrangement according to claim 8, in which arrangement the fish plate comprises on opposite sides of the support plate section a first stiffening plate section diverging to the front side of the support plate section, and a second stiffening plate section diverging to the rear side of the support plate section, and the rear sides of the ends of the guide rails are fixed to a fish plate to lean against the support plate section/support plate sections of the fish plate with tightenable joint means, which joint means form a bolt fastening, in which the head of the bolt and the guide rail are at least partly beside the first stiffening plate section when viewed in the depth direction of the guide rail, and the nut of the bolt is at least partly beside the second stiffening plate section when viewed in the depth direction of the guide rail.

11. Elevator, which comprises one or more elevator units to be moved, including at least an elevator car, and possibly a counterweight, and one or more guide rail lines of an elevator unit, which guide rail line comprises consecutive guide rails that are in line and similar in cross-sectional shape, and the consecutive guide rails are connected to each other with a joint arrangement according to claim 1.

12. Joining equipment according to claim 2, in which equipment the first stiffening plate section and the second stiffening plate section are parallel with each other and at right angles with respect to the support plate section.

13. Joining equipment according to claim 5, in which equipment the aforementioned stiffening plate sections comprise a first stiffening plate section that is at an angle with respect to the aforementioned support plate sections and bent from one support plate section towards the rear side, and a second stiffening plate section that is at an angle with respect to the aforementioned support plate sections and bent from the second support plate section towards the rear side.

14. Joining equipment according to claim 2, in which the joining equipment comprises fixing means for fixing the guide rails to the fish plate, more particularly for fixing the guide rails to lean against the support plate section of the fish plate.

15. Joining equipment according to claim 3, in which the joining equipment comprises fixing means for fixing the guide rails to the fish plate, more particularly for fixing the guide rails to lean against the support plate section of the fish plate.

16. Joining equipment according to claim 4, in which the joining equipment comprises fixing means for fixing the guide rails to the fish plate, more particularly for fixing the guide rails to lean against the support plate section of the fish plate.

17. Joining equipment according to claim 5, in which the joining equipment comprises fixing means for fixing the guide rails to the fish plate, more particularly for fixing the guide rails to lean against the support plate section of the fish plate.

18. Joining equipment according to claim 6, in which the joining equipment comprises fixing means for fixing the guide rails to the fish plate, more particularly for fixing the guide rails to lean against the support plate section of the fish plate.

19. Joint arrangement according to claim 9, in which arrangement the fish plate comprises on opposite sides of the support plate section a first stiffening plate section diverging to the front side of the support plate section, and a second stiffening plate section diverging to the rear side of the support plate section, and the rear sides of the ends of the guide rails are fixed to a fish plate to lean against the support plate section/support plate sections of the fish plate with tightenable joint means, which joint means form a bolt fastening, in which the head of the bolt and the guide rail are at least partly beside the first stiffening plate section when viewed in the depth direction of the guide rail, and the nut of the bolt is at least partly beside the second stiffening plate section when viewed in the depth direction of the guide rail.

20. Elevator, which comprises one or more elevator units to be moved, including at least an elevator car, and possibly a counterweight, and one or more guide rail lines of an elevator unit, which guide rail line comprises consecutive guide rails that are in line and similar in cross-sectional shape, and the consecutive guide rails are connected to each other with a joint arrangement according to claim 2.
